(19) United States
(12) Patent Application Publication
(10) Pub. No.: US 2008/0133243 A1
(43) Pub. Date: Jun. 5, 2008

(54) PORTABLE DEVICE USING SPEECH RECOGNITION FOR SEARCHING FESTIVALS AND THE METHOD THEREOF

(76) Inventor: Chin Chuan LIN, Taipei (TW)

Correspondence Address: BIRCH STEWART KOLASCH & BIRCH, PO BOX 747, FALLS CHURCH, VA, 22040-0747, US

(21) Appl. No.: 11/943,465

(22) Filed: Nov. 20, 2007

(30) Foreign Application Priority Data
Dec. 1, 2006 (TW) 095144739
Apr. 16, 2007 (TW) 096113399

(51) Int. Cl. G10L 21/00

(52) U.S. Cl. 704/270; 704/E19.009

(57) ABSTRACT

A portable device using speech recognition for searching festivals includes a speech receiving module, a speech recognition module, a storage module and a display module. The speech receiving module receives a speech signal. The speech recognition module is electrically connected to the speech receiving module. The speech recognition module recognizes the speech signal, and converts the speech signal to a digital signal. The storage module is electrically connected to the speech recognition module, and the speech recognition module searches corresponding festival data in the storage module according to the digital signal. The display module is electrically connected to the speech recognition module and shows the data of the festival.

### CROSS REFERENCE TO RELATED APPLICATIONS

This Non-provisional application claims priority under 35 U.S.C. §119(a) on Patent Application No(s). 096113399 filed in Taiwan, Republic of China on Apr. 16, 2007, the entire contents of which are hereby incorporated by reference.

### BACKGROUND OF THE INVENTION

1. Field of Invention

The invention relates to a portable device with a function of searching festival and a method thereof and, more particularly, to a portable device using speech recognition for searching festivals and a method thereof.

2. Related Art

With the development of the communication science and technology, a mobile phone has become a needful device in people's life. In recent years, besides improvement in the communication quality, functions of the mobile phone make progress at a tremendous pace and include music broadcasting, getting on the Internet by a mobile phone, e-mail, mobile assistant, etc., and even the conventional habit of viewing the calendar everyday is displaced by the scheduling of the mobile phone.

The scheduling and the calendar of a mobile phone bring a lot of convenience to a user, but searching festivals or a particular day in the conventional scheduling of a mobile phone is very inconvenient, and the user has to search day by day, which is uneconomical for the people against the clock in the now period. In addition, we often need to inquire Chinese calendar holidays or solar terms such as the Spring Festival, the Mid-Autumn Festival, the Beginning of Winter, etc., but the mobile phone usually only has a solar calendar database, which causes inconvenience in our daily life.

Therefore, how can we add commonly used Chinese calendar holidays and solar terms into the database of the mobile phone and even define personal important holidays, which can be assisted by a more efficient searching mode, is one of important subjects today.

### SUMMARY OF THE INVENTION

An objective of the invention is to provide a portable device using speech recognition for searching festivals and a method thereof to improve the conventional day-to-day searching mode.

To achieve the above objective, a portable device using speech recognition for searching festivals according to the invention includes a speech receiving module, a speech recognition module, a storage module and a display module. Wherein the speech receiving module receives a speech signal; the speech recognition module is electrically connected to the speech receiving module, recognizes the speech signal and converts the speech signal to a digital signal; the storage module is electrically connected to the speech recognition module, wherein the storage module includes at least a piece of festival data, and the speech recognition module gets a piece of corresponding festival data from the storage module according to the digital signal; the display module is electrically connected to the speech recognition module and displays the festival data.

Furthermore, to achieve the above objective, a method using speech recognition for searching festivals according to the invention includes the following steps: receiving a speech signal; recognizing the speech signal and converting the speech signal to a digital signal; getting a piece of corresponding festival data according to the digital signal; outputting the festival data.

From the above, the portable device using speech recognition for searching festivals and the method thereof of the invention use the function of speech recognition to achieve the objective of rapidly searching festival data. In addition, Chinese calendar data is added to the conventional scheduling, so that a user can obtain more complete festival data, and the user can define a user-defined important holiday, which is assisted by the method using speech recognition for searching festivals to improve the conventional scheduling which has no Chinese calendar data, no user-defined festivals and uses a day-to-day searching mode.

### BRIEF DESCRIPTION OF THE DRAWINGS

FIG. 1 is a system schematic diagram showing a portable device using speech recognition for searching festivals in a preferred embodiment of the invention.

FIG. 2 is a system schematic diagram showing a portable device which is a mobile phone and uses speech recognition for searching festivals in a preferred embodiment of the invention.

FIG. 3 is a schematic diagram showing a StrongARM SA 1110 chip of StrongARM series of Intel Corporation.

FIG. 4 is a flow chart showing a method using speech recognition for searching festivals according to a preferred embodiment of the invention.

### DETAILED DESCRIPTION OF THE INVENTION

The following illustrates a portable device using speech recognition for searching festivals and a method thereof according to a preferred embodiment of the invention with related drawings.

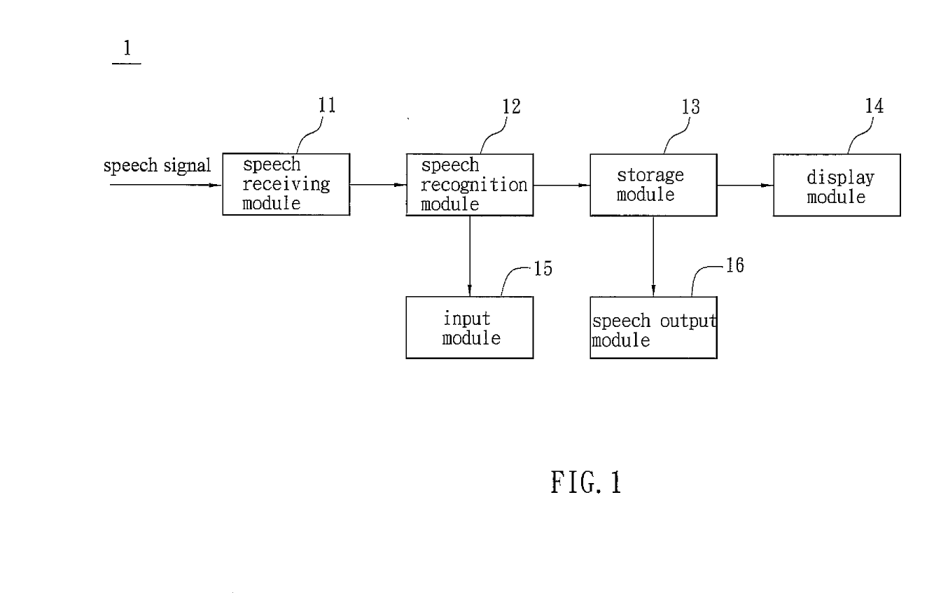

Please refer to FIG. 1 which is a system schematic diagram showing a portable device using speech recognition for searching festivals 1 in a preferred embodiment of the invention. In the embodiment, festivals include holidays, solar terms and so on.

The portable device 1 of the embodiment includes a speech receiving module 11, a speech recognition module 12, a storage module 13 and a display module 14. Wherein the speech recognition module 12 is electrically connected to the speech receiving module 11 and the storage module 13, respectively and the display module 14 is electrically connected to the storage module 13.

Please refer to FIG. 1, and in the embodiment, the speech receiving module 11 is used to receive a speech signal, and the speech recognition module 12 recognizes the speech signal received by the speech receiving module 11 and converts the speech signal to a digital signal. Next, the speech recognition module 12 can get corresponding festival data from the storage module 13 according to the digital signal, and the display module 14 shows a user the festival data.

Wherein the speech signal received by the speech receiving module 11 can include a prefix command and an intermediate command. In the embodiment, the prefix command includes year and kind of calendar appointed by a user and the intermediate command is a holiday appointed by the user. Certainly, the speech signal also can include a single command such as Tomb-sweeping Day. In addition, the storage module 13 stores all festival data.

In the embodiment, the speech receiving module 11 can be a microphone, the speech recognition module 12 can be a microprocessor control unit (MCU), and the storage module 13 can be a flash memory, a random access memory (RAM) or a hard disk. In addition, the display module 14 can be a liquid crystal display (LCD) panel or an organic light emitting diode (OLED) panel and so on.

Furthermore, please refer to FIG. 1 and the portable device 1 of the embodiment further includes an input module 15 which is electrically connected to the speech recognition module 12. A user can use the input module 15 to input another festival data such as a user-defined festival, etc., which is not stored in the storage module 13. Herein, the input module 15 can be, for example, a key-press, a touch panel and so on.

In addition, please refer to FIG. 1 again, and the portable device 1 in the embodiment further includes a speech output module 16 which is used to output the festival data in a speech mode. Herein, the speech output module 16 can be a loudspeaker.

When a user uses the portable device 1 and starts up the function of using speech recognition for searching festivals, the speech receiving module 11 receives the speech signal sent out by the user and transmits the speech signal to the speech recognition module 12. Next, the speech recognition module 12 recognizes the speech signal and converts the speech signal to a digital signal. And then, the speech recognition module 12 determines whether the digital signal is correct, if the digital signal is incorrect, the flow path of the speech recognition is restarted up; if the digital signal is correct, subsequent steps are executed.

And then, the speech recognition module 12 determines the year of a festival and the kind of the calendar (solar calendar or Chinese calendar) which need to be searched according to the digital signal and further determines whether the festival which needs to be searched is a holiday or a solar term according to the digital signal. Next, after the speech recognition module 12 determines the festival which needs to be searched, the festival data which is inquired is searched in the storage module 13 and outputted to the display module 14 to be shown for the user. Certainly, the festival data also can be outputted in speech mode through the speech output module 16.

In the embodiment, the portable device 1 can be a mobile phone or a personal digital assistant (PDA), but it is not limited.

Next, the following takes the mobile phone as an example to illustrate the concrete operation mode of the portable device 1 of the embodiment to make technical features of the embodiment more obvious.

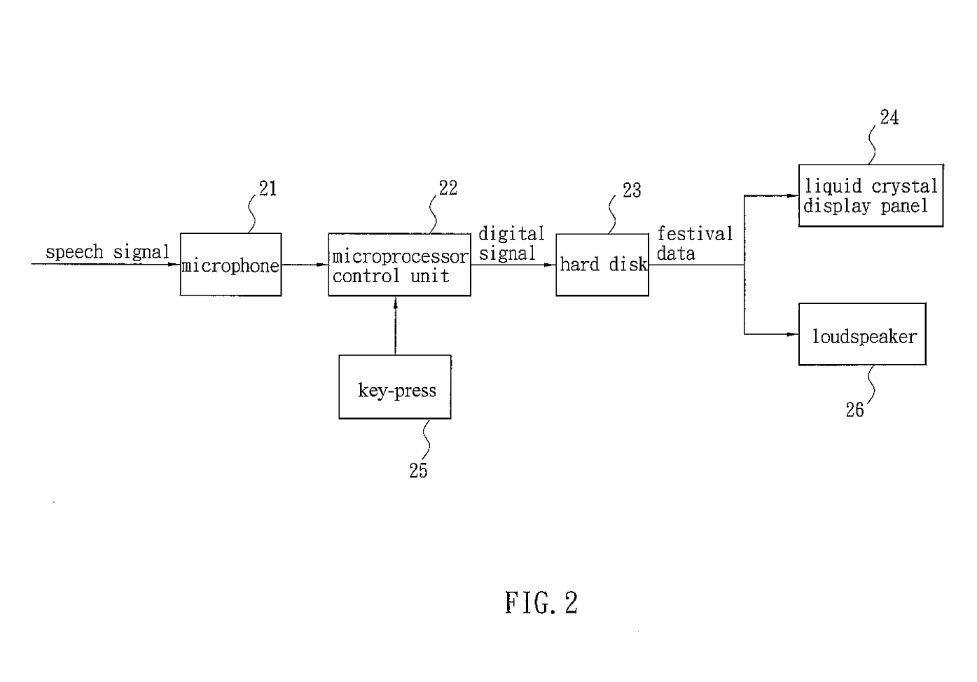

Please refer to FIG. 2. When the portable device 1 is a mobile phone, the speech receiving module is a microphone 21, the speech recognition module is a microprocessor control unit 22, the storage module is a hard disk 23, the display module is a liquid crystal display panel 24, the input module is a key-press 25, and the speech output module is a loudspeaker 26.

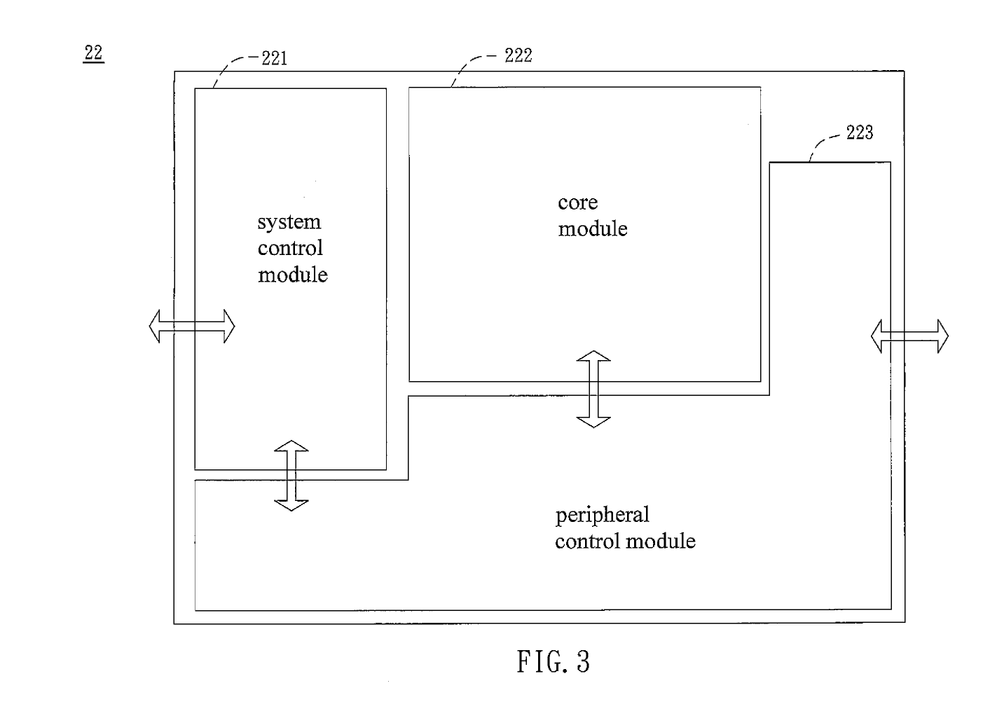

Herein, please refer to FIG. 3, and the microprocessor control unit 22 can be a StrongARM SA 1110 chip of StrongARM series of Intel Corporation. The microprocessor control unit 22 includes a system control module 221, a core module 222 and a peripheral control module 223. Wherein the system control module 221 is electrically connected to the core module 222 and the peripheral control module 223 and specializes in basic operation of the chip, such as power management, interrupting processing of the chip, restarting the chip, etc., and the peripheral control module 223 is electrically connected to peripheral devices. The core module 222 is the main processing unit, and the data which needs to be processed is inputted from the peripheral control module 223. In addition, the peripheral control module 223 outputs the command or result generated by the core module 222 and controls the operation of the peripheral devices according to the command or processing result of the core module 222.

Please refer to FIG. 2 again, when the user says 2007, Chinese calendar and Tomb-sweeping Day, the microphone 21 can receive the speech signal (2007, Chinese calendar and Tomb-sweeping Day) which includes a prefix command and an intermediate command, and in the embodiment, the prefix command is Chinese calendar of 2007 appointed by the user, and the intermediate command is Tomb-sweeping Day appointed by the user. The speech signal is transmitted to the microprocessor control unit 22, and the microprocessor control unit 22 recognizes the speech signal and converts the speech signal to a digital signal. Herein, the microprocessor control unit 22 searches out the data of Chinese calendar of 2007 from the hard disk 23 according to the digital signal converted from the prefix command first. The hard disk 23 stores a scheduling database and records all festival data. Next, according to the digital signal converted from the intermediate command, the microprocessor control unit 22 searches out the Tomb-sweeping Day data from the data of Chinese calendar of 2007 searched out previously. Finally, the microprocessor control unit 22 transmits the Tomb-sweeping Day data searched out from the hard disk 23 to a liquid crystal display screen 24 and the loudspeaker 26, and the liquid crystal display screen 24 shows the Tomb-sweeping Day data in a scheduling mode, and simultaneously, the loudspeaker 26 broadcasts the speech signal of the Tomb-sweeping Day data. Certainly, the Tomb-sweeping Day data also can be shown on the liquid crystal display screen 24 only in the scheduling mode or a word mode according to practical situations.

In addition, the user can utilize the key-press 25 to input a user-defined festival such as a personal birthday, etc., and store the user-defined festival into the hard disk 23. For example, the user utilizes an operation interface to enter a built-in scheduling database and selects a user-defined festival function, and then the user keys in the user-defined festival which he wants to input into the scheduling database, and finally, the user-defined festival is stored into the hard disk 23 and can be used in the next search by the speech recognition.

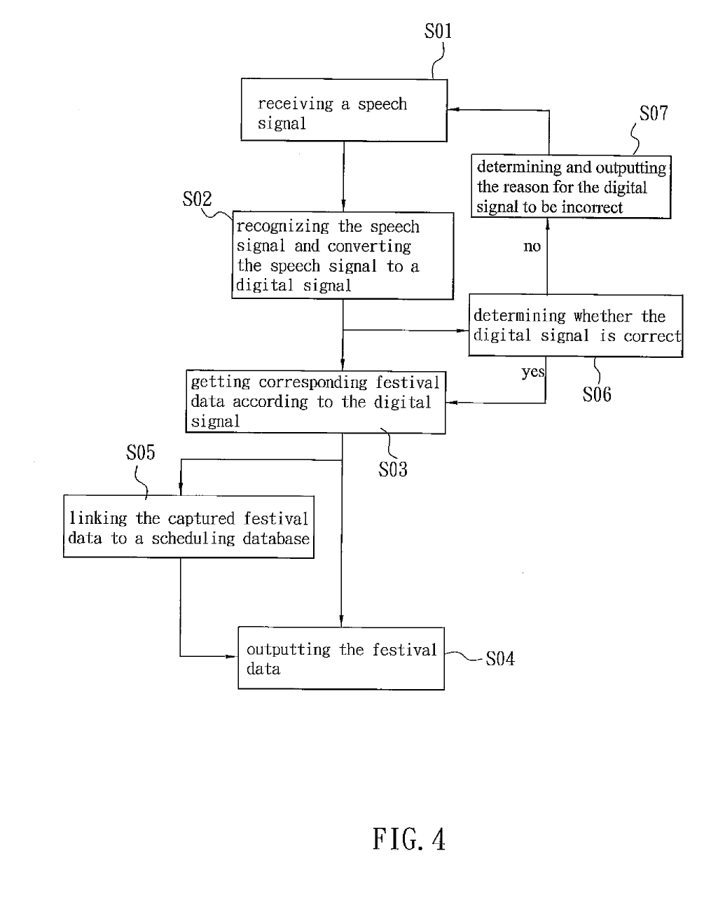

Please refer to FIG. 4. A preferred embodiment of the invention provides a method using speech recognition for searching festivals, and the method includes the following steps: receiving a speech signal (S01); recognizing the speech signal and converting the speech signal to a digital signal (S02); getting corresponding festival data according to the digital signal (S03); outputting the festival data (S04).

In addition, the method using speech recognition for searching festivals of the embodiment further includes a step of linking the captured festival data to a scheduling database (S05), and step S05 can follow the step S03, so that an image shown on a display module is presented in a scheduling mode.

Furthermore, the method using speech recognition for searching festivals of the embodiment further includes a step of determining whether the digital signal is correct (S06). Wherein if the digital signal is incorrect, the reason for the digital signal to be incorrect is determined and outputted (S07).

Steps S06 and S07 follow the step S02. When the digital signal is incorrect, the function of speech recognition can be restarted and the speech signal which needs to be recognized can be inputted again.

Features and details of the above step S01-S07 are disclosed in the above embodiment of the portable device and will not be described here for concise purpose.

Therefore, using the speech mode to search festivals is convenient and swift. The user only needs to send a command to the speech receiving device to easily get the needed festival data, which saves the user's time and facilitates steps of using a scheduling for the user.

From the above, a portable device using speech recognition for searching festivals and a method thereof according to a preferred embodiment of the invention utilize the speech recognition function to achieve the objective of swiftly searching festival data. In addition, Chinese calendar data is added to the conventional scheduling, so that a user can obtain more complete festival data, and the user can define a user-defined important holiday, which is assisted with the method using speech recognition for searching festivals to improve the conventional scheduling which has no Chinese calendar data, no user-defined festivals and uses a day-to-day searching mode.

The above mentioned is embodiments of the invention and is not for limiting the scope of the invention. Various modifications and changes without departing from the scope and spirit of the invention are within the scope of the appended claims.

What is claimed is:

1. A portable device using speech recognition for searching festivals, the portable device comprising:
a speech receiving module for receiving a speech signal;
a speech recognition module electrically connected to the speech receiving module, the speech recognition module recognizing the speech signal and converting the speech signal to a digital signal;
a storage module electrically connected to the speech recognition module, wherein the storage module comprises at least a piece of festival data, and the speech recognition module gets the corresponding festival data according to the digital signal; and
a display module electrically connected to the speech recognition module to display the festival data.

2. The portable device according to claim 1 further comprising:
an input module electrically connected to the storage module, the input module being capable of being used to input user-defined festival data to make the user-defined festival data stored in the storage module.

3. The portable device according to claim 1, wherein the storage module stores a scheduling database and the festival data is recorded in the scheduling database.

4. The portable device according to claim 1 further comprising:
a speech output module for outputting the festival data in a speech mode.

5. The portable device according to claim 4, wherein the speech output module is a loudspeaker.

6. The portable device according to claim 1, wherein the speech receiving module is a microphone.

7. The portable device according to claim 1, wherein the speech recognition module is a microprocessor control unit (MCU).

8. The portable device according to claim 1, wherein the storage module is a flash memory, a random access memory (RAM) or a hard disk.

9. The portable device according to claim 1, wherein the display module is a liquid crystal display (LCD) panel.

10. A method using speech recognition for searching festivals and applied to a scheduling database which records at least a piece of festival data, the method comprising the following steps:
receiving a speech signal;
recognizing the speech signal and converting the speech signal to a digital signal; and
getting a piece of corresponding festival data according to the digital signal; and
outputting the festival data.

11. The method according to claim 10 further comprising:
inputting a user-defined festival data to make the user-defined festival data recorded in the scheduling database.

12. The method according to claim 10 further comprising:
determining whether the digital signal is correct.

13. The method according to claim 12, wherein if the digital signal is incorrect, the reason for the digital signal to be incorrect is determined and outputted.

14. The method according to claim 10, wherein the festival data is outputted in a word or speech mode.
